(19) United States
(12) Patent Application Publication
(10) Pub. No.: US 2018/0336836 A1
(43) Pub. Date: Nov. 22, 2018

(54) FLAT LIQUID CRYSTAL DISPLAY DEVICE

(71) Applicant: Shenzhen China Star Optoelectronics Technology Co., Ltd., Shenzhen, Guangdong (CN)

(72) Inventor: Sikun Hao, Shenzhen, Guangdong (CN)

(73) Assignee: Shenzhen China Star Optoelectronics Technology Co., Ltd., Shenzhen, Guangdong (CN)

(21) Appl. No.: 15/328,952

(22) PCT Filed: Jan. 11, 2017
(86) PCT No.: PCT/CN2017/070828

§ 371 Date: Apr. 27, 2017

(30) Foreign Application Priority Data
Aug. 31, 2016 (CN) 201610799148.5

(51) Int. Cl. G09G 3/34

(52) U.S. Cl. CPC G09G 3/34

(57) ABSTRACT

Disclosed is a flat liquid crystal display device. A pixel substrate of the flat liquid crystal display device includes a plurality of repetitive pixel array units. As observed in a normal direction of a display panel, each of the pixel array units includes: a pixel electrode contact hole in a central region; a common electrode and a pixel electrode at one side of the pixel electrode contact hole; and a common electrode contact hole at the other side of the pixel electrode contact hole opposite to the common electrode and the pixel electrode. Two adjacent pixel array units share the same common electrode contact hole and are symmetrical about a central cross section of the shared common electrode contact hole. The flat liquid crystal display device is applied to the field of flat liquid crystal display device.

### CROSS-REFERENCE TO RELATED APPLICATIONS

The present application claims the priority of Chinese patent application CN 201610799148.5, entitled “Flat liquid crystal display device” and filed on Aug. 31, 2016, the entirety of which is incorporated herein by reference.

### FIELD OF THE INVENTION

The present disclosure relates to the technical field of liquid crystal display, and in particular, to a flat liquid crystal display device.

### BACKGROUND OF THE INVENTION

Liquid crystal display device is a most widely used type of flat display device currently, and has gradually become the display device with a high-resolution which is widely used in various electronic devices such as mobile phones, personal digital assistants (PDAs), digital cameras, computer screens or notebook computer screens. With development and advancements in the technologies of liquid crystal display device, people put forward higher requirements for display quality, appearance design, low cost, high permeability, and the like of the liquid crystal display device.

The liquid crystal display of the In-Plane Switching (IPS) wide-viewing angle technology allows a viewer to see only short axes of liquid crystal molecules at any time, and thus pictures viewed at various angles do not have significant differences. In this way, the viewing angle of the liquid crystal display device is improved ideally. In view of disadvantages of the twisted nematic panel (TN) mode, the first generation of IPS technology puts forward a new liquid crystal arrangement to achieve a better viewing angle. The second generation of In-Plane Switching (IPS) (S-IPS, namely Super-IPS) adopts a chevron-shaped electrode and introduces a dual-domain mode to reduce the gray-scale inversion phenomenon of the In-Plane Switching (IPS) mode at particular angles. The third generation of In-Plane Switching (IPS) (AS-IPS, namely Advanced Super-IPS) reduces the distance among liquid crystal molecules and increases the opening ratio to obtain a higher brightness.

The patent (CN201610027413.8) discloses pixel units which comprise: a first electrode and a first connecting portion connected with the first electrode, wherein the first connecting portion is connected to a first connecting line through a first via hole, and the first connecting line is connected with a first connecting line of an upper pixel unit and a first connecting line of a lower pixel unit of the pixel units.

In a high-resolution pixel, a passivation layer contact hole of a common electrode and a passivation layer contact hole of a pixel electrode cannot be located in a same horizontal plane and should be placed perpendicularly, which results in a low opening ratio and a low permeability of the liquid crystal display device, as shown in FIG. 1.

FIG. 1 is a schematic diagram of a pixel structure of a liquid crystal display device in the prior art. As shown in FIG. 1, 11 represents a common electrode contact hole, 12 represents a data line, 13 represents a scanning line, 14 represents a pixel electrode contact hole, 15 represents a pixel electrode, and 16 represents a common electrode. FIG. 2 is a schematic diagram of a pixel array of a liquid crystal display device in the prior art, and the pixel array of FIG. 2 is formed by the pixels of FIG. 1. It can be seen that, the existence of a large number of common electrode contact holes in this array results in a low opening ratio of the liquid crystal display device, thus decreasing the permeability of the liquid crystal display device.

### SUMMARY OF THE INVENTION

The present disclosure provides a flat liquid crystal display device in order to solve the problem that the liquid crystal display device has a low opening ratio and a low permeability.

The present disclosure provides a flat liquid crystal display device. A pixel substrate of the flat liquid crystal display device comprises a plurality of repetitive pixel array units. As observed in a normal direction of a display panel, each of the pixel array units comprises: a pixel electrode contact hole in a central region of the pixel array unit; a common electrode and a pixel electrode at one side of the pixel electrode contact hole; and a common electrode contact hole at the other side of the pixel electrode contact hole opposite to the common electrode and the pixel electrode. Two adjacent pixel array units share the same common electrode contact hole, and are symmetrical about a central cross section of the shared common electrode contact hole. The central cross section comprises a straight line extending in the normal direction of the display panel.

According to one embodiment, in the pixel array units, a common electrode lead is used to pass through the shared common electrode contact hole of two adjacent pixel array units.

According to one embodiment, each of the pixel array units corresponds to red, blue or green in terms of a displayed color.

According to one embodiment, the pixel array units further comprise scanning lines and data lines. As observed in the normal direction of the display panel, the scanning lines are formed in a first direction and the data lines are formed in a second direction perpendicular to the first direction.

According to one embodiment, the data lines and the scanning lines intersect to form a rectangular pixel display region comprising two long edges and two short edges.

According to one embodiment, the pixel electrode is located within the rectangular pixel display region formed by the data lines and the scanning lines.

According to one embodiment, the scanning lines are located in a first metal layer, and the data lines are located in a second metal layer.

According to one embodiment, an array substrate is provided with a first metal layer, a gate insulating layer, a semiconductor layer, an ohmic contact layer, a second metal layer, a passivation layer and a transparent conductive layer in sequence from an inner side to an outer side.

According to one embodiment, the pixel electrode is made of a transparent conductive material.

According to one embodiment, the common electrode is made of a transparent conductive material.

The above technical features can be combined in various proper ways or substituted by equivalent technical features as long as they can achieve the objective of the present disclosure.

The present disclosure provides a new pixel structure of a liquid crystal display device. In this structure, two adjacent pixel structural units are oppositely arranged; and in two adjacent rows of pixel structural units, two pixel structural units in a same column share one common electrode contact hole. Compared with the arrangement of the pixel array units in the prior art introduced in Background of the Invention, the pixel structure of the present disclosure can increase the opening ratio of the high-resolution pixel and the permeability of the display device.

### BRIEF DESCRIPTION OF THE DRAWINGS

FIG. 1 is a schematic diagram of a pixel array unit of a liquid crystal display device in the prior art as provided in Background of the Invention. In this diagram, 11 represents a common electrode contact hole, 12 represents a data line, 13 represents a scanning line, 14 represents a pixel electrode contact hole, 15 represents a pixel electrode, and 16 represents a common electrode;

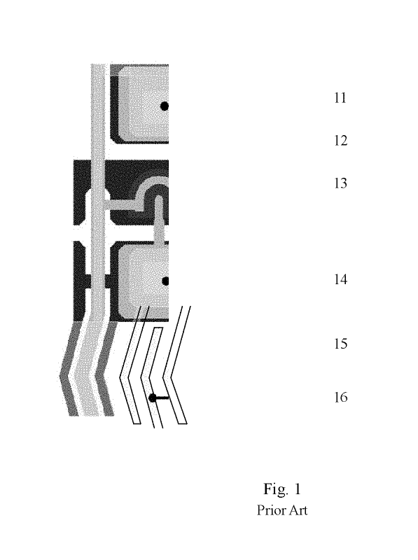

FIG. 2 is a schematic diagram of the arrangement of pixel array units of a liquid crystal display device in the prior art as provided in Background of the Invention;

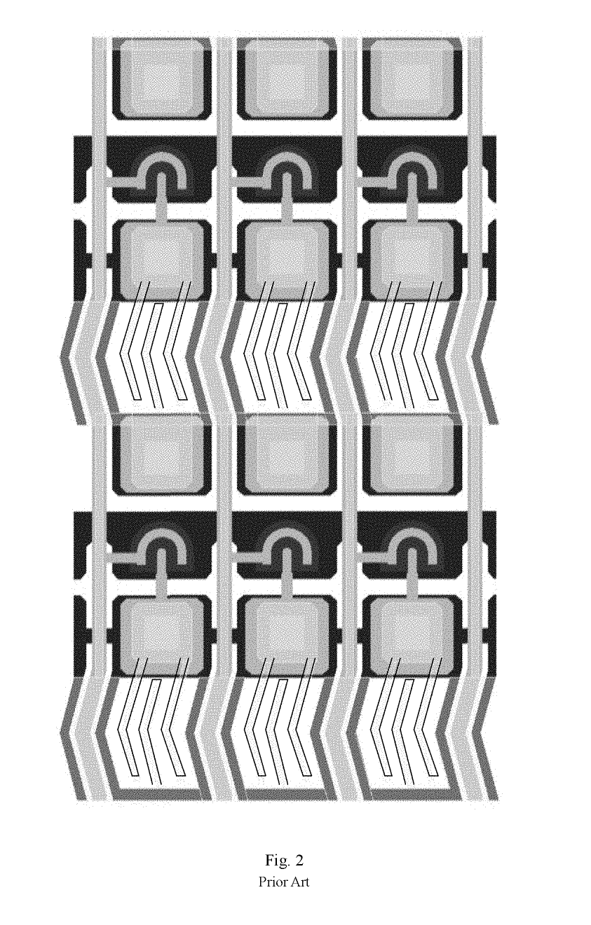

FIG. 3 is a schematic diagram of a structure of pixel array units according to one embodiment of the present application, in which two adjacent paired pixel array units sharing the same common electrode contact hole are shown. In this diagram, 21 represents a common electrode, 22 represents a pixel electrode, 23 represents a pixel electrode contact hole, 24 represents a scanning line, 25 represents a common electrode contact hole, and 26 represents a data line;

FIG. 4 is a schematic diagram of a pixel layered structure of pixel array units according to one embodiment of the present application, wherein a first metal layer, an A-si semiconductor layer and a second metal layer are respectively shown at three parts (i.e., a left part, a middle part and a right part);

FIG. 5 is a schematic diagram of a pixel layered structure of pixel array units according to one embodiment of the present application, wherein a passivation layer and an ITO/a third metal layer are respectively shown at two parts (i.e., a left part and a right part); and

FIG. 6 shows the arrangement of a pixel array structure of a liquid crystal display device according to one embodiment of the present application. In this diagram, R corresponds to red sub-pixels, B corresponds to blue sub-pixels, and G corresponds to green sub-pixels.

In the drawings, the same components are used with the same reference numerals in the same embodiment. The drawings are not drawn on scale.

### DETAILED DESCRIPTION OF THE EMBODIMENTS

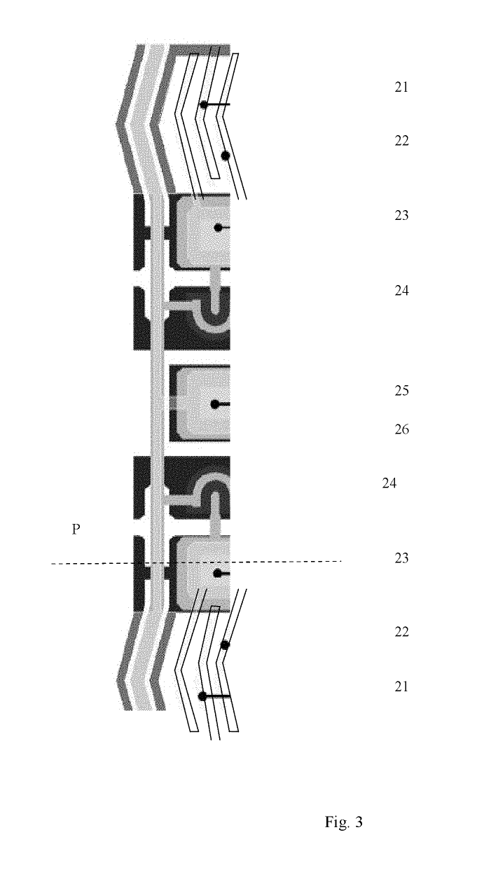

The present application provides a flat liquid crystal display device. A pixel substrate of the flat liquid crystal display device comprises a plurality of repetitive pixel array units. FIG. 3 is a schematic diagram of a structure of pixel array units according to one embodiment of the present application, in which two adjacent paired pixel array units sharing the same common electrode contact hole are shown. In this diagram, 21 represents a common electrode, 22 represents a pixel electrode, 23 represents a pixel electrode contact hole, 24 represents a scanning line, 25 represents a common electrode contact hole, and 26 represents a data line.

As shown in FIG. 3, it can be seen that, as observed in a normal direction (i.e., a direction perpendicular to the principal plane) of a display panel, each of the pixel array units comprises: a pixel electrode contact hole 23 in a central region of the pixel array unit; a common electrode 21 and a pixel electrode 22 at one side of the pixel electrode contact hole 23; and a common electrode contact hole 25 at the other side of the pixel electrode contact hole 23 opposite to the common electrode 21 and the pixel electrode 22.

Two adjacent pixel array units share the same common electrode contact hole 25, and are symmetrical about a central cross section (schematically represented by a dashed line P) of the shared common electrode contact hole 25. The central cross section comprises a straight line extending in the normal direction of the display panel.

In addition, the pixel array units further comprise scanning lines 24 and data lines 26. As observed in the normal direction of the display panel, the scanning lines 24 are formed in a first direction and the data lines 26 are formed in a second direction perpendicular to the first direction. The data lines 26 and the scanning lines 24 intersect to form a rectangular pixel display region comprising two long edges and two short edges. The pixel electrode 23 is located within the rectangular pixel display region formed by the data lines 26 and the scanning lines 24.

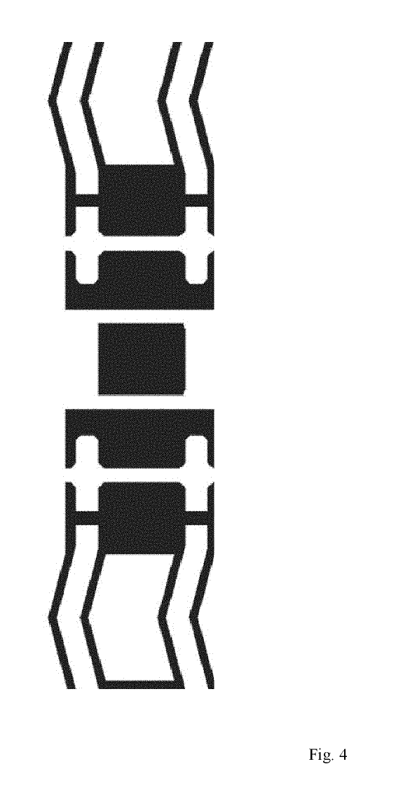

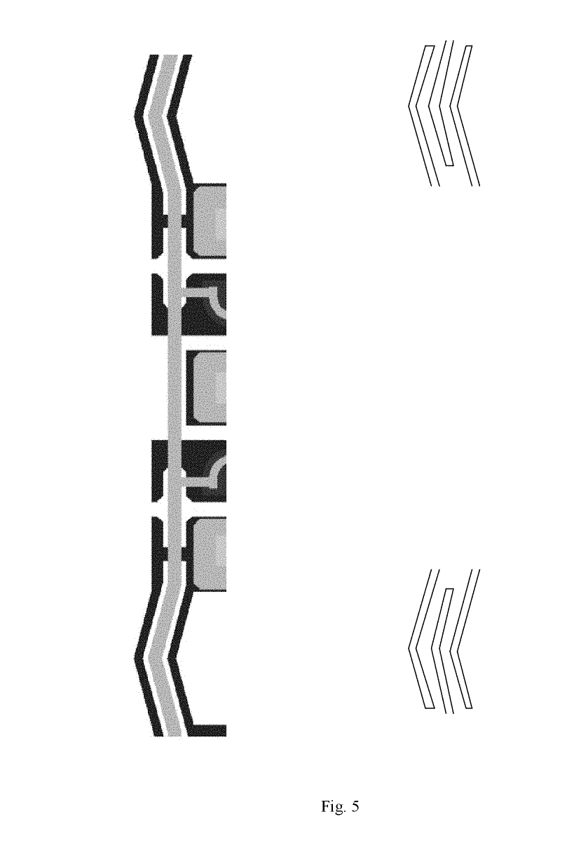

FIG. 4 is a schematic diagram of a pixel layered structure of pixel array units according to one embodiment of the present application, wherein a first metal layer, an A-si semiconductor layer and a second metal layer are respectively shown at three parts (i.e., a left part, a middle part and a right part). FIG. 5 is a schematic diagram of a pixel layered structure of pixel array units according to one embodiment of the present application, wherein a passivation layer and an ITO/a third metal layer are respectively shown at two parts (i.e., a left part and a right part).

As can be seen from FIG. 4, in the pixel array units, a common electrode lead is used to pass through the shared common electrode contact hole 23 of two adjacent pixel array units.

As shown in FIG. 4 and FIG. 5, in one exemplary embodiment, the scanning lines 24 can be located in the first metal layer, and the data lines 26 can be located in the second metal layer. An array substrate is provided with a first metal layer, a gate insulating layer, a semiconductor layer, an ohmic contact layer, a second metal layer, a passivation layer and a transparent conductive layer in sequence from an inner side to an outer side.

The pixel electrode 21 can be made of a transparent conductive material. The common electrode 23 can also be made of a transparent conductive material.

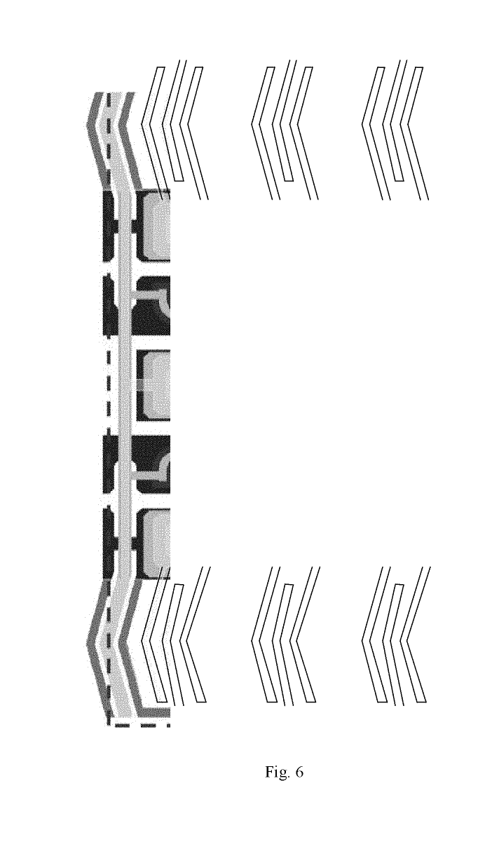

FIG. 6 shows a pixel array structure of a liquid crystal display device according to one embodiment of the present application. In this diagram, R corresponds to red sub-pixels, B corresponds to blue sub-pixels, and G corresponds to green sub-pixels. As can be seen from FIG. 6, each of the pixel array units corresponds to red, blue or green in terms of displayed color.

The present disclosure provides a new pixel structure of a liquid crystal display device. In this structure, two adjacent pixel structural units are oppositely arranged; and in two adjacent rows of pixel units, two sub-pixels in a same column share one common electrode contact hole. Compared with the arrangement of the pixel array units in the prior art introduced in Background of the Invention, the pixel structure of the present disclosure can increase the opening ratio of the high-resolution pixel and the permeability of the display device.

Although the present disclosure is described hereinabove with reference to specific embodiments, it can be understood that, these embodiments are merely examples of the principles and applications of the present disclosure. Hence, it can be understood that, numerous modifications can be made to the embodiments, and other arrangements can be made, as long as they do not go beyond the spirit and scope of the present disclosure as defined by the appended claims. It can be understood that, different dependent claims and features described herein can be combined in a manner different from those described in the initial claims. It can also be understood that, the technical features described in one embodiment can also be used in other embodiments.

1. A flat liquid crystal display device, wherein a pixel substrate of the flat liquid crystal display device comprises a plurality of repetitive pixel array units, and as observed in a normal direction of a display panel, each of the pixel array units comprises:
a pixel electrode contact hole in a central region of the pixel array unit;
a common electrode and a pixel electrode at one side of the pixel electrode contact hole; and
a common electrode contact hole at the other side of the pixel electrode contact hole opposite to the common electrode and the pixel electrode,
wherein two adjacent pixel array units share the same common electrode contact hole and are symmetrical about a central cross section of the shared common electrode contact hole, and the central cross section comprises a straight line extending in the normal direction of the display panel.

2. The flat liquid crystal display device according to claim 1, wherein in the pixel array units, a common electrode lead is used to pass through the shared common electrode contact hole of two adjacent pixel array units.

3. The flat liquid crystal display device according to claim 1, wherein each of the pixel array units corresponds to red, blue or green in terms of a displayed color.

4. The flat liquid crystal display device according to claim 3, wherein the pixel array units further comprise scanning lines and data lines, and as observed in the normal direction of the display panel, the scanning lines are formed in a first direction and the data lines are formed in a second direction perpendicular to the first direction.

5. The flat liquid crystal display device according to claim 4, wherein the data lines and the scanning lines intersect to form a rectangular pixel display region comprising two long edges and two short edges.

6. The flat liquid crystal display device according to claim 5, wherein the pixel electrode is located within the rectangular pixel display region formed by the data lines and the scanning lines.

7. The flat liquid crystal display device according to claim 6, wherein the scanning lines are located in a first metal layer, and the data lines are located in a second metal layer.

8. The flat liquid crystal display device according to claim 7, wherein an array substrate is provided with a first metal layer, a gate insulating layer, a semiconductor layer, an ohmic contact layer, a second metal layer, a passivation layer, and a transparent conductive layer in sequence from an inner side to an outer side.

9. The flat liquid crystal display device according to claim 8, wherein the pixel electrode is made of a transparent conductive material.

10. The flat liquid crystal display device according to claim 9, wherein the common electrode is made of a transparent conductive material.

11. The flat liquid crystal display device according to claim 2, wherein each of the pixel array units corresponds to red, blue or green in terms of a displayed color.

12. The flat liquid crystal display device according to claim 11, wherein the pixel array units further comprise scanning lines and data lines, and as observed in the normal direction of the display panel, the scanning lines are formed in a first direction and the data lines are formed in a second direction perpendicular to the first direction.

13. The flat liquid crystal display device according to claim 12, wherein the data lines and the scanning lines intersect to form a rectangular pixel display region comprising two long edges and two short edges.

14. The flat liquid crystal display device according to claim 13, wherein the pixel electrode is located within the rectangular pixel display region formed by the data lines and the scanning lines.

15. The flat liquid crystal display device according to claim 14, wherein the scanning lines are located in a first metal layer, and the data lines are located in a second metal layer.

16. The flat liquid crystal display device according to claim 15, wherein an array substrate is provided with a first metal layer, a gate insulating layer, a semiconductor layer, an ohmic contact layer, a second metal layer, a passivation layer and a transparent conductive layer in sequence from an inner side to an outer side.

17. The flat liquid crystal display device according to claim 16, wherein the pixel electrode is made of a transparent conductive material.

18. The flat liquid crystal display device according to claim 17, wherein the common electrode is made of a transparent conductive material.
